(19) United States
(12) Patent Application Publication
(10) Pub. No.: US 2013/0258167 A1
(43) Pub. Date: Oct. 3, 2013

(54) METHOD AND APPARATUS FOR AUTOFOCUSING AN IMAGING DEVICE

(71) Applicant: Arnold J. Gum, San Diego, CA (US)

(72) Inventor: Arnold J. Gum, San Diego, CA (US)

(73) Assignee: QUALCOMM Incorporated, San Diego, CA (US)

(21) Appl. No.: 13/433,123

(22) Filed: Mar. 28, 2012

(51) Int. Cl. H04N 5/232

(52) U.S. Cl. 348/349; 348/E05.045

(57) ABSTRACT

Methods and apparatus for autofocusing an image consider object movement or an object's color when selecting an object to focus on. In some implementations, input is received corresponding to an object color to focus on. An image is then captured with an image sensor. Objects are detecting in the image and an object is selected based on the object's color corresponding to the color to focus on. In some implementations, the image sensor may then be autofocused to bring the selected object into focus.

### TECHNICAL FIELD

The present embodiments relate to imaging devices, and in particular, to methods and apparatus for the automatic focusing of imaging devices.

### BACKGROUND

The integration of digital processing technology with imaging devices has enabled more powerful and easier to use photographic products. For example, the ability to digitally control an imaging device's shutter speed, aperture, and sensor sensitivity has provided for improved picture quality in a variety of imaging environments without the need for the photographer to manually determine and set these parameters for each environment.

Autofocus capability has also made capturing high quality photographs easier by enabling almost any photographer, regardless of skill, to obtain a clear image in most imaging environments. Autofocus capability may have also reduced the workload of professional photographers. This may enable the photographers to focus more of their energies on the creative aspects of their trade, with a corresponding increase in the quality of photographs produced by these photographers.

A variety of autofocus methods may be used in modern digital imaging devices. For example, because images with higher contrast may tend to have a sharper focus, some autofocus methods seek a focus position that provides an image with the highest contrast. Some other autofocus methods may optimize the contrast within a portion of the image.

While the integration of digital processing technology and photography has enabled several advancements as described above, several problems remain unsolved. For example, the autofocus capabilities of digital cameras remain ineffective in some imaging environments. While common portraits and landscape scenes may obtain sufficient focus when a camera is left in an autofocus mode, focusing an imaging device for some scenes may still require a manual focus to be performed. In some imaging environments, for example, a photographer's subject may be positioned between, behind, or even partially obscured by other objects. This may make it difficult for the camera to determine which object to focus on. This may result in the wrong object being selected for focus. In some imaging environments, the camera may frequently change the selected focus.

This may be the case when photographing wildlife. A deer may appear within a forested environment, with several trees between the photographer and the deer. In this imaging environment, the deer may still be quite visible, such that a proper focus will provide an appealing photograph. However, because many autofocus methods are not optimized for this environment, the deer may not be brought into focus when an imaging device is in an autofocus mode. For example, some imaging devices may attempt to focus on the trees between the deer and the photographer instead of on the deer itself. A similar result may occur when attempting to photograph a bird in a tree. Traditional autofocus methods may have difficulty obtaining a focus on the bird and not on the branches or leaves of the tree. This may be especially problematic for traditional autofocus methods if the leaves and branches are closer to the photographer than the bird.

Other imaging environments may present additional challenges for traditional autofocus methods. For example, in some imaging environments, a photographer may wish to focus the image on a moving object. Sports photography may present this imaging environment. An image of a baseball field may include several players on the field, with one player running between bases. A photographer may wish to capture an image of the running player, with that player having the sharpest focus. The player running between bases may be a different distance from the imaging device than other players on the field, and thus a particular focus setting may bring the running player into a proper focus. Traditional autofocus methods may be unable to achieve the proper focus in this environment for several reasons. First, traditional autofocus methods may not be able to identify which of the multiple players in the frame should be provided with the best focus. For example, some autofocus methods may chose to focus on the player closest to the camera. If the player running from first base to second base is further from the camera than the first baseman for example, this method may not achieve a proper focus.

Other methods may seek a compromise focus that provides a good overall focus. With this method, players that are an “average” distance from the camera may be most in focus, while players closer to or further from the photographer than the “average” player may be less in focus.

The movement of the player may also create challenges for traditional autofocus methods. Some traditional autofocus methods may capture multiple images when determining the best focus position. Some of these methods may capture each of the multiple images with a different focus position. Data derived from each of the images captured during the autofocus process may then be compared. This relative comparison of the data derived from the several images may be used to determine the best focus. For example, the contrast of images at each focus position may be compared when determining how to autofocus the imaging device.

This relative comparison may work well when the content of each image captured at each focus position is relatively constant. This may allow the relative comparison to evaluate how a changing focus position affects the characteristics of each image. When the multiple images captured during the autofocus process include not only changes to a focus position, but also changes to the image itself, some inaccuracy may be introduced to this relative comparison. This may result in the autofocus method selecting an inferior focus position.

### SUMMARY

Some of the present embodiments may include a method of focusing a digital imaging device. The method may include capturing an image with an image sensor, identifying one or more objects within the image, selecting at least one object to focus on based, at least in part, on the at least one object's movement relative to an image background, and autofocusing the image sensor on the selected object.

One innovative aspect disclosed is a method of focusing a digital imaging device. The method includes capturing an image with an image sensor. The captured image may include objects and background. The method also includes identifying one or more objects within the image, and selecting at least one of the identified objects to focus on based, at least in part, on the identified object's movement. The image sensor is then autofocused on the at least one selected object. In some implementations, the selecting at least one of the identified objects includes determining motion vectors for at least a portion of the one or more identified objects. The selecting may be based, at least in part, on the size of the motion vectors. In some implementations, the selecting of at least one of the identified objects is based, at least in part, on the identified objects' movement relative to an image background. In some implementations, the selecting of at least one of the identified objects is based, at least in part, on the identified objects' movement being consistent with a pan motion of the device. In some implementations, the selecting of at least one of the identified objects is based, at least in part, on the identified objects' relative position within the image. The autofocusing of the image sensor may include receiving input indicating the image sensor should be focused, at least in part, on the movement of the at least one selected object. The method may include displaying a user interface on an electronic display indicating whether the image sensor should be focused, at least in part, on object movement. In some implementations, the selecting at least one of the identified objects is further based on one or more colors of the identified objects.

In some implementations, the method may include identifying at least two objects within the image, and autofocusing the image sensor on the selected object may include adjusting an aperture of the image sensor to focus the image sensor on the at least two objects. In some implementations, predicting a position of one or more objects at a point in time may be based on each object's motion, with the one or more objects including the at least one object selected for focus. The autofocusing of the image sensor may also be based on the selected at least one object's predicted position.

Another innovative aspect includes an imaging device. The device may include an image sensor, and a sensor control module configured to capture an image with the image sensor. The device may also include an object detection module configured to identify one or more objects within the captured image, and a focus prioritization module configured to select at least one object to focus on based, at least in part, on the at least one object's movement, and a master control module, configured to autofocus the image sensor on the selected at least one object.

In some implementations, the device may included an object motion detection module configured to determine motion vectors for at least a portion of the one or more identified objects. In some implementations, the focus prioritization module is further configured to select at least one object to focus on based, at least in part, on the at least one object's movement relative to an image background. In some implementations, the focus prioritization module is further configured to select at least one of the identified objects based, at least in part, on the at least one object's movement being substantially consistent with a pan of the device. In some implementations, the focus prioritization module is further configured to select at least one object based, at least in part, on the at least one object's position within the image.

The device may include an input processing module, configured to receive input indicating that the image sensor should be focused based, at least in part, on the at least one object that is moving. In some implementations, the device may include an electronic display, and the master control module may be further configured to display a user interface indicating whether the image sensor should be focused, at least in part, on object movement.

Another innovative aspect disclosed is an imaging device. The imaging device includes means for capturing an image with an image sensor. The captured image may include objects and background. The device may also include a means for identifying one or more objects within the image, and a means for selecting at least one of the identified objects to focus on based, at least in part, on the at least one object's movement, and a means for autofocusing the image sensor on the at least one selected object. In some implementations, the means for capturing an image comprises an image sensor. In some implementations, the means for selecting one of the identified objects selects the object based, at least in part, on the size of the motion vectors. In some implementations, the means for selecting an object selects an object also based, at least in part, on the object's relative position within the image.

In some implementations, the means for selecting selects an object to focus on based, at least in part, on the object's movement relative to an image background. In some implementations, the means for selecting selects an object to focus on based, at least in part, the object's movement being substantially consistent with a pan of the device. In some implementations, the imaging device also includes a means for predicting a position of one or more objects at a point in time based on each object's motion, wherein the one or more objects includes the object selected for focus, and wherein the autofocusing of the image sensor is based on the selected object's predicted position.

Another innovative aspect disclosed is a method of focusing a digital imaging device. The method includes receiving input from a user indicating a selected color, capturing an image with an image sensor, identifying one or more objects within the captured image, selecting a first object to focus on based, at least in part, on the selected color, and autofocusing the image sensor on the selected object. In some implementations, the selecting of the first object to focus on is also based on the first object's relative position within the image. In some other implementations, the method includes selecting at least a second object to focus on based, at least in part, on the selected color, with the autofocusing including focusing on both the first object to focus on and the second object to focus on. In some implementations, selecting a first object to focus on is further based, at least in part, on one or more of the first object's size within the captured image. In some implementations, the method further includes receiving input indicating a second color not to focus on, wherein the selecting of the first object to focus on is further based on the second color.

Another innovative aspect disclosed is an imaging device. The imaging device includes an image sensor, an input device, and an input processing module, configured to receive input from the input device indicating a selected color. The device also includes a sensor control module, configured to capture an image with the image sensor, an object detection module, configured to identify one or more objects within the captured image, and a focus prioritization module, configured to select at least one object to focus on based, at least in part, on the selected color, and a master control module, configured to autofocus the image sensor on the at least one selected object. In some implementations, the device includes an electronic display that is configured to display a prompt for input on the color to focus on. In some implementations, the focus prioritization module is further configured to select an object based at least in part on the object's position within the image. In some implementations, the focus prioritization module is further configured to select an object based at least in part on the object's size within the captured image. In some implementations, the focus prioritization module is further configured to select an object based at least in part on the object's movement relative to an image background.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 shows an imaging environment including a photographer capturing an image of a bird within a natural setting that includes branches and leaves.

FIG. 2 shows an imaging environment including a photographer capturing an image of race cars in motion on a racetrack.

FIG. 3 is a block diagram of an imaging device implementing at least one operative embodiment.

FIG. 4 is a flow chart of a process for autofocusing an imaging device.

FIG. 5 is a flowchart of a process for prioritizing moving objects within a scene

FIG. 6 is a flowchart of a process for autofocusing an imaging device.

FIG. 7 is a flowchart of a process for autofocusing an imaging device.

FIG. 8 is an image that may be captured as part of a method of autofocusing an imaging device.

### DETAILED DESCRIPTION

Implementations disclosed herein relate to methods and systems for autofocusing a digital imaging device. One implementation is a system or method configured to capture an image with an imaging device. Once the image is captured, one or more objects within the image are identified. At least one object to focus on may then be selected based on the at least one object's motion relative to the background of the image. The image sensor may then be adjusted to focus on the at least one selected object. This method may improve the focus of the at least one object in motion when compared to traditional autofocus methods. Thus, for example, a digital imaging device such as a digital camera may be pointed towards a person running in a football game. The system would identify the person running based on their motion relative to the remaining background, and focus the image sensor on that person, even if other football players in the game were closer or more centered with respect to the digital camera. The motion relative to the background may also be used to prioritize focus on the subject rather than the background.

Other embodiments may select at least one object to focus on based on the at least one object's color. In this embodiment, the digital imaging device may receive input from a user that indicates a particular color of interest. Objects with a color matching the color of interest may be selected for focus. In one example, the user may wish to focus on a red bird in a green bush. The user would select a red color on the digital imaging device, and thereafter the device would attempt to focus on objects with the matched red color, even if objects of a different color were closer, or more prominent, in the scene. In another example, the camera may autoselect a color that is different and unique from the background such as the aforementioned red bird surrounded by a green background. One skilled in the art will recognize that these embodiments may be implemented in hardware, software, firmware, or any combination thereof.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As described earlier, traditional autofocus methods suffer from an inability to achieve adequate focus in certain imaging environments. For example, imaging environments that present multiple objects within an image at different distances from the image sensor may make it difficult for an autofocus method to determine which object or objects of the multiple objects should be selected for focus. Other imaging environments may include objects in motion. Objects in motion may not be recognized by traditional autofocus methods. This may result in an inferior focus when compared to the methods disclosed herein.

Some of the described methods and apparatus take advantage of a photographer's prior knowledge of their imaging environment. A photographer may know in advance their imaging environment will present backgrounds and subjects that include certain characteristics. For example, a wildlife photographer may understand that their image backgrounds may include objects such as trees, branches, leaves, grass, or flowers. The photographer may also know that their photographic subjects have certain characteristics. For example, a wildlife photographer may be intending to photograph birds, and specifically cardinals, which may have a red color. In some of the methods and apparatus disclosed herein, the photographer may provide, for example, input via a user interface that indicates red objects should be given a higher priority for focus by an imaging device. Some implementations may also allow a photographer to configure that brown and green objects should be deprioritized such that the imaging device will focus on any object that does not have these color features. Thus, when a photographer captures images using devices according to the disclosed methods or systems, the digital imaging device may provide an improved focus based on the color information selected in the device by the photographer.

In some other implementations, the uniqueness of an object's color within the image may determine whether it is selected for focus. For example, an imaging environment may include several objects, including one yellow object and several blue objects. In some implementations, the yellow object may be selected for focus because its color is unique to other objects detected in the image. In this implementation, the system would measure the proportion of different colors within a scene. Based on this selection, the colors that are most unique or in the lowest proportion based on a predetermined threshold would be selected for autofocus. Thus, using this setting, the user could continually autofocus on the most unique colored object within the scene, above a preset threshold. For example, the user could select to autofocus on any object that had a color that was less than 50, 40, 30, 20, 10, 5, 2, or 1 percent of the total color of a scene. This setting would allow autofocusing on a bird of any color that was present in a large foliage of green or brown bushes. In a related implementation, the autofocus color may be determined based on its low incidence of occurrence in natural situations. For example, bright blues, reds and yellows may be prioritized higher in some implementations than more frequently occurring natural colors, such as earth tones (browns, tans), sky tones and foliage tones (a range of greens) in an outdoor photography setting.

In some other implementations, other object characteristics may be considered along with object movement or object color when selecting an object for focus. For example, the position of the object within the image may also be considered when selecting an object to focus on. This may improve the autofocus when an imaging environment presents several objects of the same color. In this environment, one particular object may be selected for focus at least in part if the object is located closer to the center of the frame than other objects of the same color.

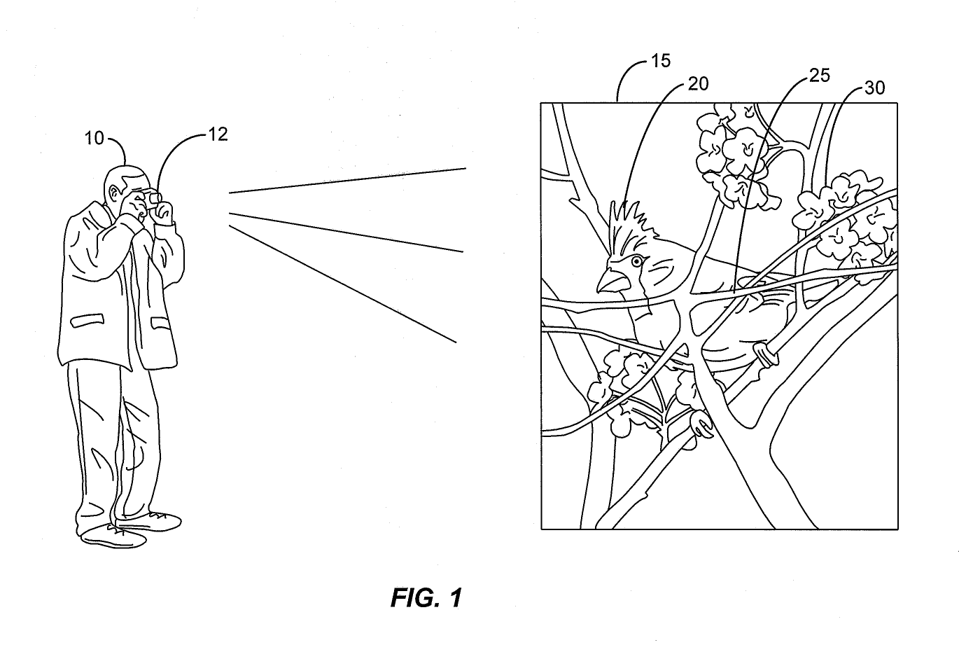

FIG. 1 shows an imaging environment including a photographer 10 using a camera 12 capturing an image 15 of a bird 20 within a natural setting that includes branches 25 and leaves 30. The camera 12 includes software instructions or commands that provide an improved focus of the bird in the illustrated imaging environment. As described below, the camera 12 may include software and hardware that receives input indicating a color of objects to focus on. Objects matching this color are then given a higher priority for focus. For example, the photographer 10 may select, via an electronic user interface on the camera 12, that red objects should be given a higher focus priority than objects of a color other than red. In the illustrated example, the branches 25 and leaves 30 may be brown or tan in color. If the photographer has previously provided input to the camera 12 that red objects should be prioritized for focus, the camera 12 will select a focus position that provides a better autofocus on the red bird than on the green or brown branches. In an embodiment, the color of objects to focus on may also be automatically determined based on the objects position in the image and/or the uniqueness of the object when compared against one or more background colors. For example, an object that is position more centrally in the image may be selected over objects with the same color that are positioned at the edges of the image. Similarly, the uniqueness of the shape or color of the object may also be used to automatically select that object a higher focus priority.

In some implementations, the camera may be programmed to determine that multiple objects should be brought into focus. These implementations may adjust the shutter speed, aperture, and image sensor sensitivity to improve the focus and clarity of the multiple objects when the image is captured. For example, some implementations may increase the depth of field of a captured image to ensure multiple objects obtain adequate focus.

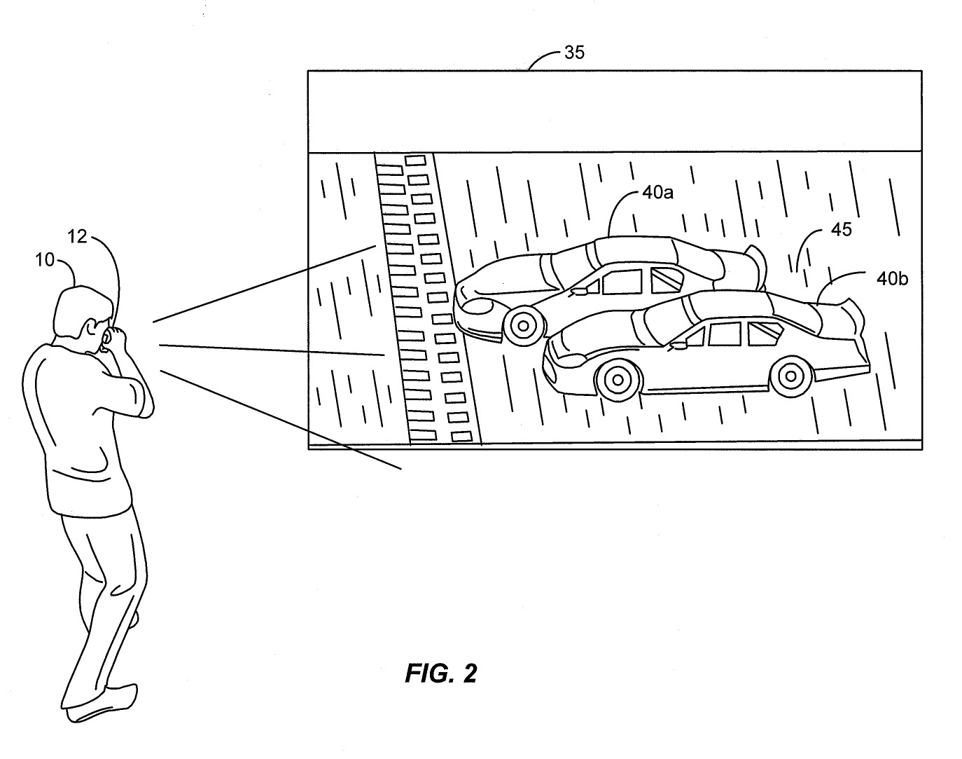

FIG. 2 shows an imaging environment including the photographer 10 using the camera 12 to capture an image 35 of race cars 40a-b in motion on a racetrack 45. The camera 12 may include software and hardware that improves the focus on the race cars 40a-b by prioritizing the focus of the moving race cars 40a-b when compared to other objects, such as the stationary racetrack 45, in the image. Some implementations may also determine a shutter speed and/or an image sensor sensitivity to improve image clarity in the presence of the detected motion. Some implementations may include a configuration setting that allows a photographer to select a threshold defining how much movement an object would have to be given an autofocus priority. For example, the camera may be programmed to autofocus on objects that are moving 1, 3, 5, 8, 10, 12, 15, 20, 25, 40, 50, 75 or more percent faster than other objects within the scene.

Some implementations may also track objects based on how much they stay focused in the center of the camera while the camera is being panned across a moving scene. For example, the photographer 10 may pan the camera 12 across the racetrack 45 as he is trying to capture an image of the racecar 40a. In this implementation, the camera 12 includes software and hardware that detects the panning motion of the camera. The panning may be detected by an accelerometer or other motion sensing device that is integrated with the camera device. One or more captured scenes may be analyzed to identify one or more objects that may be moving in a direction consistent or substantially consistent with the panning motion. Some implementations may identify objects consist with a pan of the camera without the assistance of a separate motion detector. For example, these implementations may determine motion vectors for objects in one or more images. A pan direction and speed may be determined based on the direction and length of the motion vectors. Objects with smaller motion vectors may be selected as consistent with a pan of the device. These objects may then be prioritized for focus.

In these implementations, if the camera software determines that race car 40a is maintaining its position at the center of the field of view during the panning motion, the camera 12 may autofocus on the race car 40a because of its relatively stable position in the frame as the camera 12 is being panned by the photographer 10.

Some implementations may also predict the motion of the moving object. For example, these implementations may predict the position of a moving object at a point in time in the future when an image such as a photographic snapshot will be captured. These implementations may then determine a focus position or setting that focuses the moving object at the time the snapshot is captured. For example, the focus or setting may be determined based upon an estimated rate of change of focus and the acceleration/deceleration of that rate of change of focus. These implementations may then set the focal distance, and capture the image at the time used for the prediction. For example, instructions in the object motion detection module 355 may represent one means for predicting the motion of a moving object. Instructions in the master control module 375 may represent one means to determine a focus position that focuses the moving object at the time an image is captured.

Some other implementations may also adjust the shutter speed, aperture, and image sensor sensitivity to improve the focus and clarity of the moving object when the image is captured.

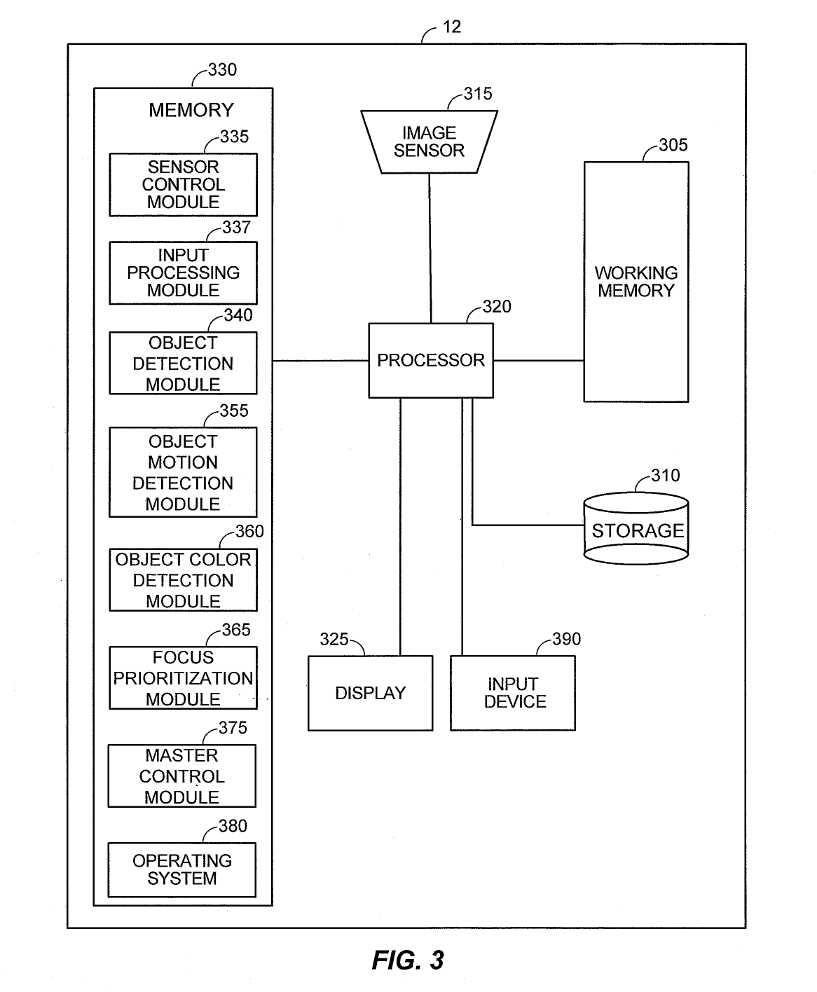

FIG. 3 is a block diagram of the imaging device 12 implementing at least one operative embodiment. The imaging device 12 includes a processor 320 operatively coupled to several components, including a memory 330, an image sensor 315, a working memory 305, a storage 310, a display 325, and an input device 390. The memory 330 stores several modules. These modules contain instructions that configure the processor 320 to perform certain functions as described below. For example, an operating system module 380 includes instructions that configure the processor 320 to manage the hardware and software resources of the device 10. A sensor control module 335 includes instructions that configure the processor 320 to control the image sensor 315. For example, some instructions in the sensor control module 335 may configure the processor 320 to change the focus position of the image sensor 315. Other instructions in the sensor control module 335 may configure the processor 320 such that the processor 320 controls the image sensor 315 to capture an image. Therefore, instructions in the sensor control module 335 may represent one means for capturing an image with an image sensor. Other instructions in the sensor control module 335 may control settings of the image sensor 315. For example, the shutter speed, aperture, or image sensor sensitivity may be set by instructions in the sensor control module 335.

An input processing module 337 includes instructions that configure the processor 320 to read input data from the input device 390. For example, input data may indicate a color to focus on. Other input data may indicate which autofocus modes of imaging device 12 are active. For example, input may be received indicating that a “focus on moving objects” mode is active. Other input may be received indicating that a “focus on object's with a unique color” mode is active. Other input may include indications of one or more colors not to focus on.

An object detection module 340 may configure the processor 320 to detect objects within an image captured by the image sensor 315. Therefore, instructions in the object detection module 340 may represent one means for identifying one or more objects within an image. An object motion detection module 355 may include instructions that configure the processor 320 to detect motion for each object within one or more images captured by the image sensor 315. The object motion detection module 355 may use any one of the motion detection techniques known in the art. For example, the object motion detection module 355 may determine motion vectors for at least a portion of one or more identified objects. The motion vectors of each object may then be evaluated to determine the degree and direction of the motion of each object. An object color detection module 360 may determine a color of each object detected by the object detection module 340.

A focus prioritization module 365 may determine a focus priority for each object detected by the object detection module 340. For example, the focus prioritization module 365 may receive object color data from the object color detection module 360. This information may be used to determine an object's focus priority. The focus prioritization module 365 may also receive data from the object motion detection module 355. The motion data received may also be used to determine an object's focus priority. The focus prioritization module 365 may also select one or more objects for focus. The selection may be based on the priority of objects determined as above. Therefore, instructions in a focus prioritization module represent one means for selecting one or more objects to focus on based, at least in part, on the object's movement relative to an image background. Instructions in the focus prioritization module may also represent a means to select one or more objects to focus on based, at least in part, on an object's color. The object's color may correspond to a color received via input from the input device 390.

A master control module 375 may include instructions that configure processor 320 to control the overall operation of the device 12. For example, the master control module 375 may include instructions that configure the processor 320 to invoke subroutines in the sensor control module 335 that change the focus position of the image sensor 315 and capture images with the image sensor 315. The master control module 375 may also include instructions that display a user interface on the display 325. For example, the master control module 375 may display a prompt on the display 325. The prompt may request input indicating an object color. The master control module 375 may then configure processor 320 to receive input via an input device, such as input device 390. The input may indicate the color of an object that should be prioritized for focus. Therefore, instructions in a master control module may represent one means for receiving input indicating a color to focus on.

Alternatively, in some implementations the prompt may instead request whether movement should be utilized to prioritize an object's focus. Master control module 375 may also invoke subroutines in the focus prioritization module 365 in order to prioritize the focus of multiple objects detected in an image captured by the image sensor 315. The focus prioritization module 365 may return, in some implementations, one or more selected objects to focus on to the master control module 375. The master control module 375 may also include instructions that configure the processor 320 to autofocus the image sensor 315 on the one or more selected objects. Therefore, instructions in the master control module 375 may represent one means for autofocusing an image sensor on one or more selected objects.

The input device 390 may take on many forms depending on the implementation. In some implementations, the input device 390 may be integrated with the display 325 so as to form a touch screen display. In other implementations, the input device 390 may include separate keys or buttons on the imaging device 12. These keys or buttons may provide input for navigation of a menu that is displayed on the display 325. Some menus displayed on the display 325 may receive input that selects particular colors or other settings. For example, input from the input device 390 may select a color via a menu displayed on the display 325. In other implementations, the input device 390 may be an input port. For example, the input device 390 may provide for operative coupling of another device to the imaging device 12. The imaging device 12 may then receive input from an attached keyboard or mouse via the input device 390.

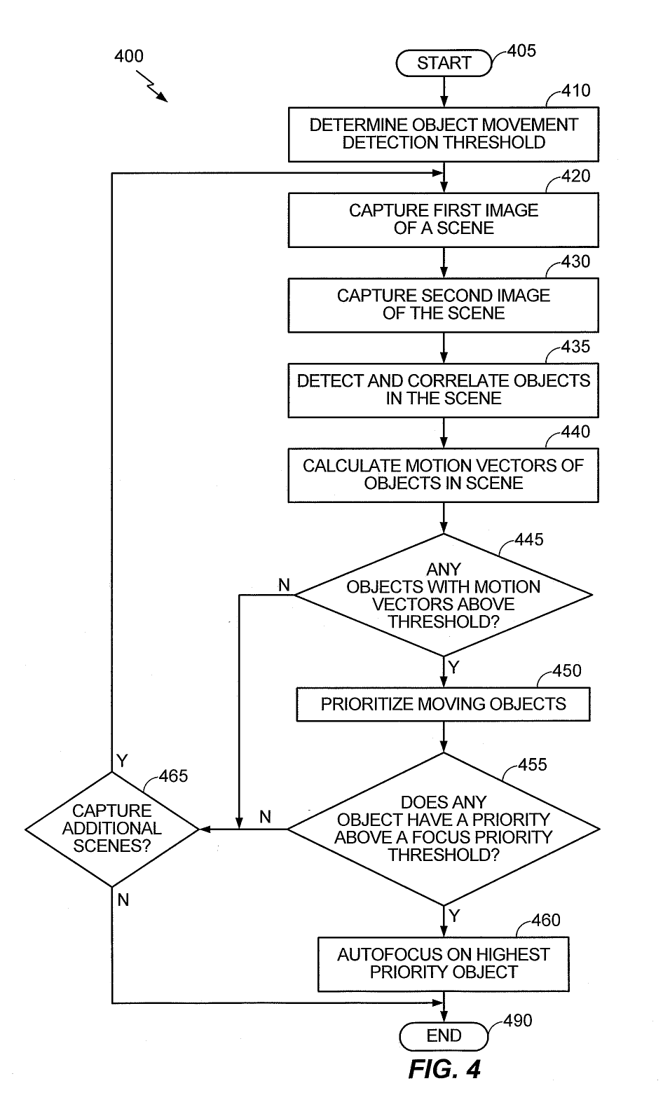

FIG. 4 is a flow chart of one process 400 for autofocusing an imaging device on a moving object. Process 400 may be performed by the imaging device 12 illustrated in FIG. 3. Process 400 begins at start block 405 and then moves to block 410, where an object movement detection threshold is determined. This threshold may be used in some implementations to determine which objects are classified as moving objects and which objects are classified as non-moving or static objects. Objects with motion vectors of a length longer than the threshold may be considered moving objects, while objects with motion vectors of a length shorter than the threshold may be considered non-moving objects. This threshold may have a default value that is set when the imaging device or camera is manufactured. Some implementations may allow the movement detection threshold to be configurable, either by a user or via a privileged configuration interface. Access to the privileged configuration interface may be restricted via a password or other means such that only individuals with specialized expertise or training are able to modify the threshold. After the object movement detection threshold is set, process 400 moves to block 420, where a first image of a scene is captured. The image may be captured with an image sensor. Process 400 then moves to block 430, where a second image of the scene is captured. This second image may also be captured with an image sensor. Process 400 then moves to block 435, where objects in the scene are detected. Objects may also be correlated between the first image and the second image. Block 435 may be performed by instructions included in the object detection module 340, illustrated in FIG. 3.

After objects are detected and correlated between the two images, process 400 moves to block 440, where the motion vectors for each of the objects are calculated. As illustrated, some implementations of process 400 may capture multiple images to detect motion. These implementations may calculate motion vectors of objects based on the position of an object in a first image and the position of an object in a second image. In some implementations, the first image and the second image may be captured using the same focus position. In other implementations, the first image and second image may be captured using different focus positions. Based on the motion vectors, these implementations may adjust the focus priority of the objects detected in the images.

Process 400 then moves to decision block 445, where it is determined if any of the detected objects have motion vectors that exceed the motion detection threshold determined in block 410. If no objects have motion vectors exceeding the motion detection threshold, then process 400 moves to decision block 465, where it is determined if there are additional scenes that should be processed. For example, some implementations may provide an autofocus mode that operates continuously, with images repeatedly processed and analyzed in order to determine an appropriate autofocus solution and/or a maximum exposure time for the scene. In these implementations, for example, process 400 may return to block 420 from decision block 465. Process 400 may then repeat from block 420.

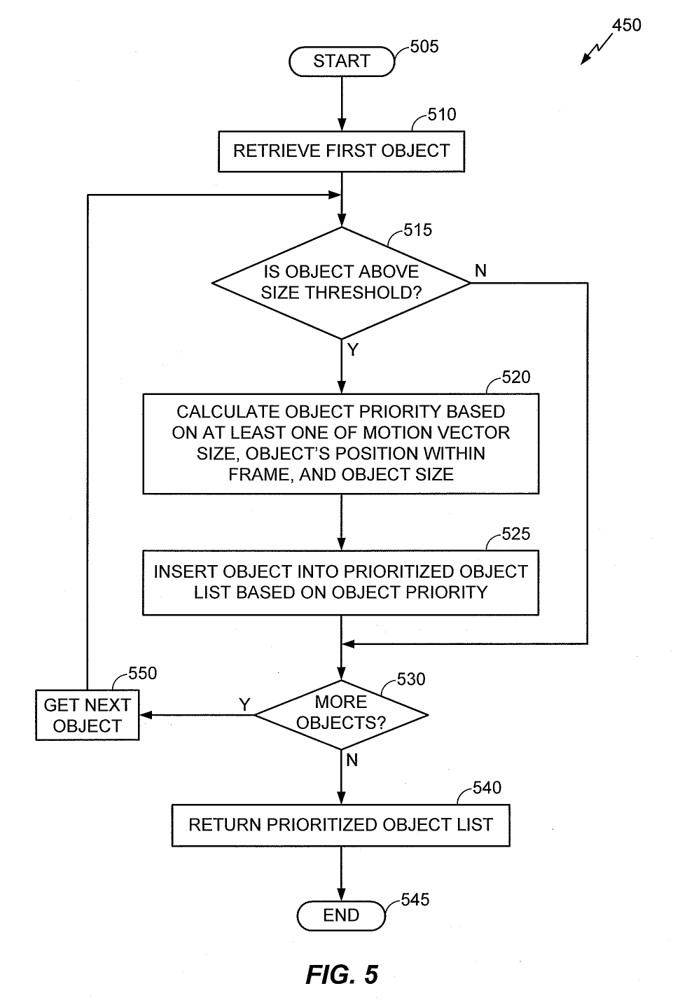

Returning to the discussion of block 445, if the motion vectors of at least one object exceed the object motion detection threshold determined in block 410, then process 400 moves to block 450 from block 445, where the detected moving objects are prioritized. In some scenes, there may be more than one object with motion vectors above the object movement detection threshold determined in block 410. When analyzing such a scene, process 400 may determine which of the multiple moving objects should be focused on. In some implementations, a priority of each moving object may be determined, with the imaging device or camera focused on the moving object of the highest priority. More detail is provided on moving object prioritization below in the discussion of FIG. 5. After the moving objects are prioritized, process 400 then moves to decision block 455, where a determination is made whether any of the prioritized objects have a priority above a focus priority threshold. A focus priority threshold may set a lower limit on an object's focus priority in order for an imaging device to auto focus on that object. If at least one object has a priority above the focus priority threshold, process 400 then moves to block 460, wherein the imaging device or camera is autofocused on the highest priority object. Block 460 may be performed by instructions included in the master control module 375, illustrated in FIG. 3.

Autofocusing on the higher priority object or objects may include selecting a lens focus position that provides for increased contrast of the moving object within the scene. Autofocusing on a moving object may include adjusting one or more image sensor parameters. For example, the shutter speed, sensor sensitivity, and aperture of the image sensor may be adjusted. In some focus modes, the amount of ambient light may also be considered. Instructions implementing the auto focus method, such as instructions in the master control module 375, may also estimate the speed of the higher priority object. Based on the estimated speed, and ambient light or light produced by a flash device, a shutter speed may be determined. For example, a shutter speed that reduces blur of the moving object or objects may be selected. When the shutter speed is reduced, other imaging parameters may also be adjusted to maintain an adequate exposure. For example, the aperture of the image sensor may be increased. The sensor sensitivity may also be increased to compensate for a reduced shutter speed.

Autofocusing on the highest priority object or objects may also include adjusting exposure parameters so as to focus on more than one object. For example, processing block 460 may determine that multiple objects have a focus priority above the priority threshold. To bring those objects to an adequate focus, processing block 460 may further adjust imaging parameters such as the aperture of the image sensor. By decreasing the aperture, a depth of field of an image captured by an image sensor may be increased. This may provide more objects with an adequate focus when compared with an image captured at a larger aperture setting. As mentioned above, autofocusing the image sensor may further include adjusting other imaging parameters in addition to adjusting the aperture. For example, with a smaller aperture, the shutter speed may need to be increased or sensor sensitivity increased to provide for an adequate exposure.

Some implementations may provide several focus modes that control to what extent the imaging device adjusts imaging parameters. For example, an imaging device may include parameters for fstop (aperture), sensor sensitivity, or shutter speed. The parameters may be set to specific values, or may each be set to an “automatic” mode in some implementations. Some implementations may then adjust these parameters when the parameters are set to automatic mode.

After the image sensor has been autofocused in block 460, some implementations may capture an image using the autofocused image sensor. After processing of block 460 is complete, process 400 moves to end block 490.

If no object has adequate priority for autofocus, process 400 moves from block 455 to decision block 465, where it is determined if additional scenes should be captured. Additional scenes may be captured, for example, if the camera is operating in a continuous autofocus mode. In a continuous autofocus mode, some implementations may continuously capture and analyze images for motion. If a determination is made at decision block 465 that more scenes should be captured, process 400 returns to the block 420. If no additional scenes will be captured, process 400 moves to end block 490. In some embodiments, if there is no motion over the threshold, some embodiments may automatically select a different mode of determination of focal priority, such as a scenic mode.

While process 400 is illustrated as capturing a first and second image and calculating motion vectors for objects based on the first and second images, other implementations may detect motion based on the degree and direction of blur of an object in the image. These implementations may further base the motion detection on the shutter speed or sensitivity of the image sensor. These implementations may be able to detect motion of one or more objects based on a single image.

In addition to object movement, some implementations may select one or more objects to focus on based at least in part on other object characteristics. For example, the selection of an object may also be based on an object's position within the image. For example, objects positioned closer to the center of the image may be prioritized above objects positioned closer to the edge of an image. The selection of the object may be further based on the object's color.

Some implementations may combine a plurality of object characteristics to determine a focus priority for each object detected in block 450. The focus priority may be increased based on the relative motion of the object. The focus priority may be increased or decreased based on the object's color or the object's relative position of the object within the image. In these implementations, after each object's focus priority has been adjusted based on these and other object characteristics, the object with the highest priority may be selected for focus.

In some other implementations, more than one object may be selected for focus. For example, if the focus priorities of a plurality of objects are within a threshold or a threshold percent of each other, the plurality of objects may all be selected for focus. In these implementations, the focus position of an image sensor may be adjusted to improve the focus of the selected objects. In some of these implementations, the depth of field may be adjusted by adjusting the aperture of the image sensor such that the plurality of objects may all be brought into adequate focus. An image may then be captured using the selected focus position and the selected depth of field. This may allow multiple objects to be in focus.

FIG. 5 is a flowchart of a process 450 for prioritizing moving objects within a scene. Process 450 may be implemented in the focus prioritization module 365 illustrated in FIG. 3. Process 450 begins at start block 505 and then moves to block 510 where the first object is retrieved. Process 450 then moves to block 515 where the object's size is compared to a size threshold. In some implementations, objects smaller than a threshold size may not be considered for focus prioritization. This may avoid some spurious effects that could occur if the imaging device or camera attempted to focus on very small objects in a scene, such as an object in the background. In the illustrated implementation, if the object's size is smaller than the size threshold, the object is not prioritized or inserted into a priority list, which is used to determine an object to autofocus on in the illustrated implementation. Instead, if the object is smaller than the threshold, process 450 moves to decision block 530, where it is determined if there are additional objects that should be analyzed in process 450.

If the object's size is above the size threshold, process 450 moves to block 520, where the object's priority is calculated based on at least one of the size of the object's motion vector(s), the position of the object within the scene, and the object's size. In some implementation, each characteristic may be assigned a weight, based on that characteristics' relative importance to the focus prioritization. An object may also be scored on each characteristic. For example, an object may be assigned a size score, a position score, and a movement score. A weighted sum or average of these characteristics may then be created for each object. Multiple detected objects may then be prioritized based on their weighted sums or averages. Other implementations may consider only one of these characteristics, with the prioritization performed entirely based on a single characteristic.

In some implementations, how objects are prioritized may be configurable. For example, the weights and/or thresholds associated with each characteristic discussed above may be configured to vary the prioritization. In some implementations, the determination of the thresholds or weights may be done by a device user, for example via a user interface. In some implementations, the imaging device may include an API that allows custom prioritization software to be developed. For example, in some implementations, the focus prioritization module 365 may provide an API “hook.” The hook may allow custom software to alter the prioritization determined by the focus prioritization module.

After the priority of an object is determined in block 520, the object is inserted into a prioritized object list based on the priority. Process 450 then moves to block 530 where it determines if there are additional objects to analyze. If there are additional objects to prioritize, process 450 moves to processing block 550 where the next object is obtained. Process 450 then returns to decision block 515 and process 450 repeats. Note that while the process 500 illustrates the processing of each object in a serial manner, other implementations may process objects in parallel. For example, two or more threads or processes may be created or used, and each identified object allocated to one of the processes or threads for processing. Each process or thread may then insert the processed object into a priority list that is appropriately protected with mutexes to ensure thread safety.

If no additional objects are identified for processing in decision block 530, the process 450 moves to block 540, where the prioritized list of objects is returned. In some implementations, the prioritized list may be returned as a parameter to a subroutine implementing process 450. In other implementations, the prioritized list may be a return function value to a function implementing process 450. Process 450 then moves to end block 545.

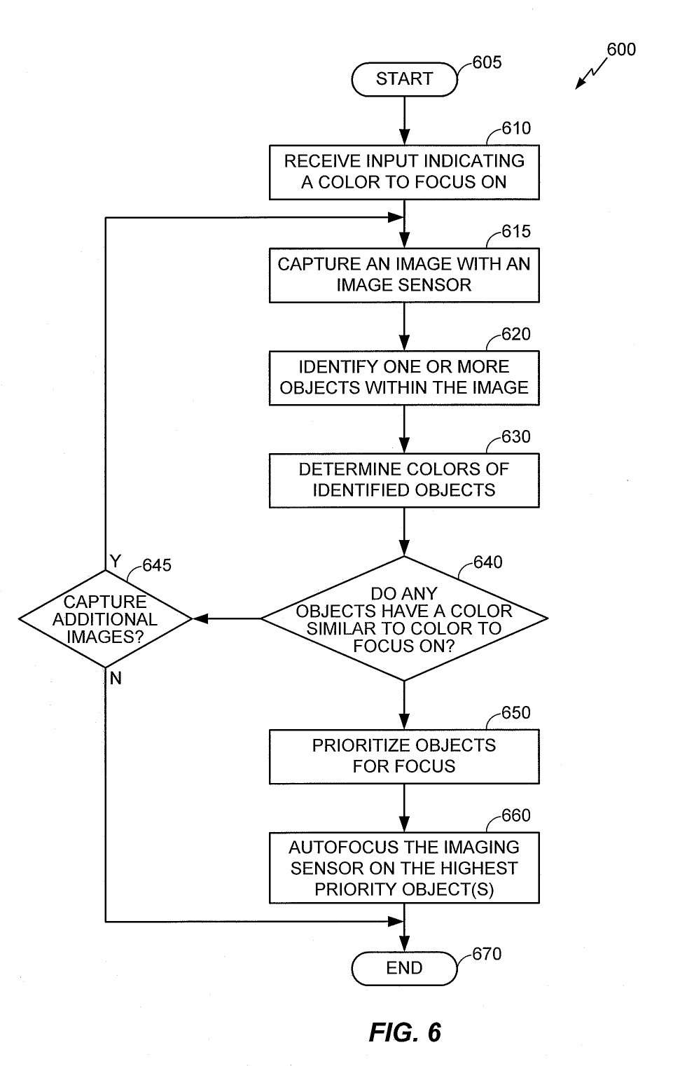

FIG. 6 is a flowchart of a process 600 for auto-focusing an imaging device based on a target color. In some embodiments, multiple colors may be prioritized. The process 600 may be performed by the imaging device 12, illustrated in FIG. 3. The process 600 begins at start block 605 and then moves to processing block 610 where input is received indicating a color or colors to focus on. Block 610 may be performed by instructions included in a master control module 375 as illustrated in FIG. 3. The input may be received by input device 390, also illustrated in FIG. 3. Process 600 then moves to block 615 where an image is captured. Block 615 may be performed by instructions included in the sensor control module 335, illustrated in FIG. 3. Process 600 then moves to block 620, where one or more objects are identified within the image. Block 620 may be performed by instructions included in object detection module 340, illustrated in FIG. 3.

Process 600 then moves to block 630, where the colors of the identified objects are determined. Process 600 then moves to decision block 640, where it determines whether any objects have a color similar to the color to focus on, which was received in block 610. How process 600 determines whether an object has a color similar to the color to focus on may vary by implementation. Some implementations may map the color to focus on and an object's color to a color space, such as a RGB color space, or a YCbCr color space. A distance may then be computed between the object's color and the color to focus on in the space. If the distance is below a threshold, the object's color may be considered “similar” to the color to focus on. If decision block 640 determines that at least one object has a color similar to the color to focus on, process 600 moves to block 650, where the objects are prioritized for focus.

In some scenes, multiple objects may have a color similar to the color to focus on. When imaging these scenes, it may be necessary to prioritize among the objects to determine which of the objects the imaging device or camera should be auto-focused on. In some implementations, the prioritization of the objects may be based on the distance of each object's color from the color to focus on in a multi-dimensional color space. For example, an object with a color closer to the color to focus on in a three dimensional color space may be prioritized higher than an object with a color that is further from the color to focus on in the three dimensional space.

In other implementations, the distance of the object's color from the color to focus on may be but one consideration in determining the focus priority of the object. For example, the object's size and position within the image may also be considered. Some implementations may assign a size score to each object, with the magnitude of the size score proportional to the size of the object in the scene. Thus, larger objects will receive a larger size score than smaller objects. Objects may also be assigned a position score. Objects closer to the center of the scene may be assigned a position score higher than objects further from the center of the scene. Each object may also be assigned a color match score that is inversely proportional to the distance of the object's color to the color to focus on in a color space. In these implementations, objects with colors closer to the color to focus on receive higher color match scores than objects whose colors are further from the color to focus on in a color space.

In some implementations, the color, size, and position scores may be added or averaged to determine the priority of an object. The priorities of each object may then be compared to determine which object has the highest priority. In some implementations, each of these scores may also be assigned a weight, and a weighted sum or average for each object created. The weighted sum or average may determine the priority of each object. In some implementations, default weights may be assigned when the imaging device or camera is designed. In some implementations, the weight of one or more characteristics may be configurable. The weights may be configurable via a user interface provided on an electronic display of an imaging device or camera. In some implementations, the weights may be configurable via a communication interface provided by an input device. For example, some imaging devices may include a USB or other I/O port that enables electronic communication with external devices. An API may be defined that enables external devices to configure imaging device parameters via communication over the I/O port.

Once objects with a color similar to the color to focus on are prioritized, process 600 then moves to block 660, where the imaging device is autofocused on the highest priority object or objects. Block 660 may be performed by instructions included in a master control module 375, as illustrated in FIG. 3. In some implementations, an image may be captured after the sensor is autofocused. Process 600 then moves to end block 670.

Returning to block 640, if no objects have a color similar to the color to focus on, process 600 moves to decision block 645. In block 645, a determination is made as to whether additional images should be captured. In some other implementations, if no objects have a color similar to the color to focus on, an alternative focus method may be selected. For example, a focus may be selected based on the centrality of objects in the scene, or the movement of the objects within the images. Some implementations may select a focus to provide a good focus for an overall scene. For example, the contrast of the image captured by the image sensor may be maximized by the selected focus setting. In some implementations, the autofocus capability may operate continuously, such that images are continuously captured and evaluated for objects to focus on. In these implementations, process 600 may move from decision block 645 to block 615, where another image is captured and process 600 repeats. In other implementations, process 600 may move from block 645 to end block 670.

When selecting the highest priority object to focus on, some implementations may choose a single object. Other implementations may choose multiple objects to focus on. In some implementations, the nature of the scene may determine whether a single object or multiple objects are selected for autofocus. For example, in some scenes, several objects may have a similar focus priority. In some scenes, this may result from multiple objects being similar to the color to focus on. In other scenes, this may be caused by the components of the focus priority calculation resulting in similar focus priorities for two or more objects.

For example, in one scene, a first object's color may be an exact match with the color to focus on. The distance between this object's color and the color to focus on within a multi dimensional color space may be zero or very small. This may result in this object having a high color match score. This first object may be positioned at the edge of a scene, resulting in a low position score for the first object. A second object's color may be less similar to the color to focus on, resulting in a lower color match score than the first object. The second object may also be positioned closer to the center of the scene than the first object, resulting in the second object having a higher position score than the first object. As a result, in some implementations, the resulting priorities of the first object and the second object may be similar. With these scenes, some implementations may select both images for autofocus. In these implementations, auto-focusing the image sensor on the selected objects may include both selecting a focus position, and also selecting a depth of field for an image. The selected depth of field may enable both objects to have an adequate focus at the selected focus position.

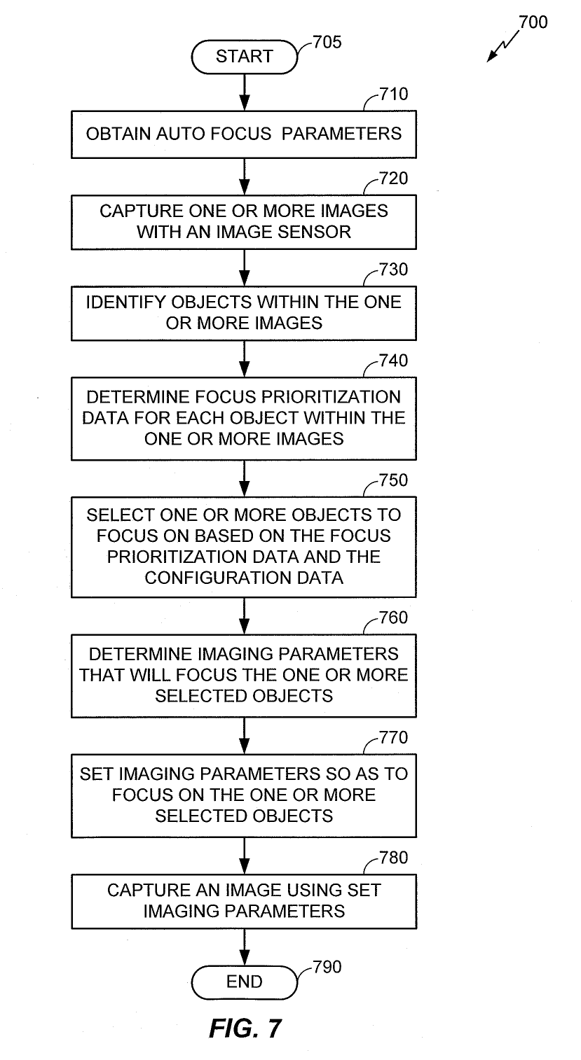

FIG. 7 is a flowchart of a process for autofocusing a digital imaging device. Process 700 may be implemented by the imaging device 12 illustrated in FIG. 3. Process 700 begins at start block 705 and then moves to block 710 where autofocus parameters are obtained. Block 710 may be performed at least in part by instructions included in the master control module 375 illustrated in FIG. 3. Autofocus parameters may provide general control to an autofocus method, for example, the method described by process 700. These parameters may not be specific to particular objects detected as part of process 700.

In some implementations block 710 may include receiving input that defines the values of one or more autofocus parameters. For example, a first set of autofocus parameters may indicate one or more first colors. Objects of the first colors may be given a higher focus priority than objects of a different color. Alternatively, objects of a color similar to one of the first colors may be given a higher color match score, as described below. In some implementations, an object's color match score may be inversely proportional to the distance of the object's color to the one or more first colors within a multi-dimensional color space.

A second set of autofocus parameters may indicate one or more second colors. This second set of parameters may indicate that objects with a color similar to one or more of the second colors be given a lower focus priority than objects of a color different from the one or more second colors.

A third set of autofocus parameters may include a boolean parameter indicating whether object movement should be considered when determining the focus priority of objects identified in an image. A fourth set of parameters may indicate the weight assigned to each score assigned to an object. For example, a fourth set of parameters may indicate weights for a color match score, an object position score, and an object size score.

A fifth set of autofocus parameters may include boundary values for shutter speed, aperture, or image sensitivity. These boundary values may set limits on how an autofocus method may set these parameters when autofocusing the imaging device or camera.

Other autofocus parameters may define one or more autofocus modes. For example, autofocus modes may include “focus on moving objects,” “focus on objects with a unique color,” “focus on objects of a specific color,” or “focus on objects closest to the center of the image.” In a “focus on objects with a unique color” mode, objects with a more unique color within the image may be given a higher focus priority than objects with a less unique color.

After the autofocus parameters have been obtained, process 700 moves to block 720, where one or more images are captured with an image sensor. Block 720 may be implemented by instructions included in the sensor control module 335, illustrated in FIG. 3. In some implementations that capture more than one image, some of the images may be captured at different focal distances. In some implementations that capture more than one image in block 720, some of the images may be captured at the same focal distance. Some implementations may utilize the multiple images captured in block 720 to detect motion across the multiple images.

Process 700 then moves to processing block 730. In processing block 730, objects are identified in the one or more images. In implementations that capture more than one image, identifying objects may include correlating an object in one image with an object in another image. Process 700 then moves to block 740, where the focus prioritization data for each identified object is determined. In some implementations, the focus prioritization data may include at least one of the object's colors, the uniqueness of the object's color, the object's motion, the object's size, and the object's position within the image. In some implementations, determining focus prioritization data may include reading the data from autofocus parameters. Determining focus prioritization data may also include analyzing the one or more images to obtain the data. For example, one or more images may be analyzed to determine an object's color or movement.

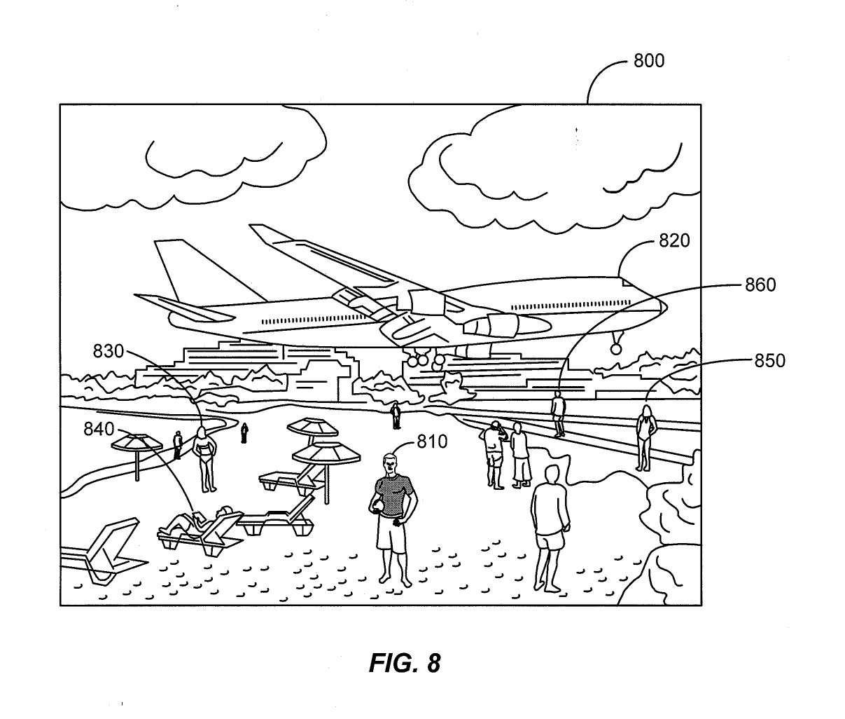

Process 700 then moves to block 750 where one or more objects to focus on are selected based on the focus prioritization data and the configuration data. Block 750 is explained in more detail below in the discussion of FIG. 8.

Process 700 then moves to block 760, where imaging parameters that affect the focus of the one or more selected objects are determined. Several imaging parameters may affect the focus of the selected objects. For example, a lens focus position may affect the focus of the one or more objects. Other parameters may also affect the focus of the one or more objects. For example, if multiple objects are selected, the selected objects may be different distances from the image sensor. In this imaging environment, a single focal length may not be able to achieve adequate focus for all of the selected objects unless other imaging parameters are adjusted. An aperture setting for the image sensor may also be determined that will increase or decrease the depth of field. The aperture setting may be adjusted to allow at least two or more of the selected objects to achieve an adequate focus. The determination of this adjustment may be bounded by boundary parameters obtained in block 710. Other image sensor settings, such as shutter speed and image sensor sensitivity, may also be adjusted to provide a proper exposure given the determined aperture.

Once the imaging parameters are determined, process 700 moves to block 770 where the determined imaging parameters are set so as to focus the image sensor on the one or more selected objects. In some implementations, this may include writing or otherwise sending image capture parameters to an image sensor. Block 770 may also include physically changing the focal position of a lens to correspond to a focal distance that focuses the lens on the selected objects. In some implementations, block 770 may be considered autofocusing an image sensor on the one or more selected objects. Process 700 then moves to block 780, where an image is captured using the set imaging parameters. Process 700 then moves to end block 790.

FIG. 8 is an image that may be captured as part of a method of autofocusing an imaging device. For example, the image represented in FIG. 8 may be captured during the performance of process 400, specifically block 420 or block 430, illustrated in FIG. 4, process 600, specifically block 615, illustrated in FIG. 6, or process 700, specifically block 720, illustrated in FIG. 7. The previously described methods of autofocusing an image device may identify objects within image 800. For example, these methods may identify the airplane 820 and the beach goers as objects, 810, 830, 840, 850, and 860.

Some implementations may then prioritize the detected objects to determine which one or more objects to focus on. These implementations may organize the focus data for the detected objects in a table similar to table 1 presented below:

TABLE 1

| | | (c) | (d) | | | | (h) | (i) |
|---|---|---|---|---|---|---|---|---|
| | | Object | Object | (e) | (f) | (g) | Object | Object |
| | (b) | Color | Color | Object | Object | Object | Focus | Focus |
| (a) | Object | Match | Uniqueness | Movement | Position | Size | Priority | Priority |
| Object | Color | Score | Score | Score | Score | Score | Impl. #1 | Impl. #2 |
| Object | Blue | Low | High | High | High | High | High | Medium |
| 820 | | | | | | | | |
| Object | Orange | High* | Medium | Low | High | Medium | Medium | High |
| 810 | | | | | | | | |
| Object | Skin | Low | Low | Low | Low | Medium | Low | Low |
| 840 | | | | | | | | |
| Object | Skin | Low | Low | Low | Low | Medium | Low | Low |
| 830 | | | | | | | | |
| Object | Skin | Low | Low | Low | Low | Medium | Low | Low |
| 850 | | | | | | | | |
| Object | Orange | High* | Medium | Low | Low | Medium | Medium | Medium |
| 860 | | | | | | | | |

*Assumes the illustrated implementations have received an input indicating that orange objects should be selected for focus or be given a higher focus priority than objects of other colors.

Table 1 shows at least one implementation's organization or structure for a focus prioritization table. The rows of table 1 represent individual objects. For example, each row may represent an object detected by the object detection module 340 illustrated in FIG. 3. Columns b-g of Table 1 each represent a particular object characteristic which may be used to, at least in part, determine the focus priority of each object. Some implementations may implement only a subset of these columns. Other implementations may implement the columns illustrated in Table 1 and other additional columns not illustrated.

The cells of Table 1, columns (b)-(g) may record the “scores” for the object characteristics represented by each column. For example, object 720 is illustrated as having a high color uniqueness score, but a low color match score. While the cells of Table 1 in columns b-g are shown with scores of “high”, “medium”, and “low”, these values are only for purposes of illustration. Some implementations would provide for numerical values in the cells of the columns. For example, some implementations may sum or average the scores of each object to create a focus priority. This focus priority may be recorded in column (h) or column (i), discussed below.

Column (a) of Table 1 identifies the object for purposes of this description. Each object listed is identified in FIG. 8. Column (b) indicates the color of each detected object. In some implementations, the focus priority (represented by columns (h) or (i), may be based on the object color. For example, an implementation may receive input indicating one or more colors. When a detected object matches one of these colors, that object's focus priority may be increased. These implementations may utilize column (c), which represents how closely the object's color matches a color received as input as a color to focus on. The color match score of column (c) may be determined based on a distance from each object's color to one or more colors configured to be colors to focus on. The distance may be within a multi-dimensional color space, such as an RGB color space or a YCrCb color space. An object's color match score may be inversely proportional to the distance from the object's color to the one or more colors configured for focus.

Column (d) indicates a color uniqueness score for each object. The color uniqueness score of an object may represent the relative uniqueness of the object's color when compared to other objects of the image. In some implementations, a color's uniqueness score may be proportional to the distance between the object's color and all the other detected objects' color within a multi-dimensional color space. For example, these implementations may first calculate the distance from an object's color to each of the other detected objects' colors. These distances may then be summed to create a color uniqueness score. This process may then be repeated for each detected object.

In the illustrated example of FIG. 8, three of the detected objects, object 840, 830, and 850 have a detected color of “skin.” Because other objects within the image have the same color, these objects may not be considered to have a unique color. For example, using the method of determining a color uniqueness score described above, the distance between the colors for objects 830, 840 and 850 in a multi dimensional color space may be zero. This may result in these objects having a relatively low color uniqueness score. Alternatively, object 820 is the only blue object, so it has a high color uniqueness score. Two objects, objects 810 and 860 have an orange color, resulting in a medium color uniqueness score for those objects. Objects 820, 810, and 860 all have higher uniqueness scores when compared to objects 830, 840, and 850.

Column (e) represents the object's movement score. If movement of an object is detected, the object's movement score may be higher than the movement score of a more static object. In some implementations, an object's movement score may be based on the size of motion vectors determined for that object. For example, some implementations may correlate an object across multiple captured images, for example a first image and a second image. Motion vectors for the object may be calculated that map the position of the object in the first image to the position of the object in the second image. The absolute size of these motion vectors may indicate the degree or speed of the motion of the object relative to a static image background. The movement score illustrated in table 1 may be based on the size of these motion vectors. As can be seen in the illustrated example of FIG. 8 and Table 1, the airplane 820 has a higher movement score than the other objects in the table. The airplane is moving to the right in the illustrated image at a speed that may be faster than the other detected objects.

Column (f) represents each detected object's position score. In some implementations, objects positioned closer to the center of the image may have a higher position score than objects located closer to the edges of the image. In the illustrated example, both objects 820 and 810 have a high position score. These objects are illustrated close to the center of the image. The remaining objects are located closer to the edges of the image and therefore have a lower position score.

Column (g) represents each detected object's size score. In some implementations, objects are assigned a size score proportional to their relative size in the image. In the illustrated example of image 800, the airplane 820 is clearly of a larger size than the beachgoers, for example, beachgoer 810. Therefore, the airplane's size score may be larger than the beachgoer's size score.

Columns (h) and (i) each represent the result of different implementation's prioritization of the detected objects based on the data provided in columns (a)-(g) of Table 1. While each object's priority is represented in Table 1 as either “high”, “medium', or “low”, these focus priorities are for illustrative purposes only. Some implementations may provide for numerical scores and focus priorities in order to enable summing, averaging, and numerical comparisons of object scores and priorities. For simplicity, the scores are represented as illustrated.

The focus priority, as shown in columns (h) and (i) may be based on one or more of the object's color match score (column (c)), the object's color uniqueness score (column (d)), the object's movement score (column (e)), the object's position score (column (f)), or the object's size score (column (g)).

Some implementations may add or average one or more of the scores represented in table 1 to determine an object focus priority. Other implementations may assign a weight to each column. A weighted sum or weighted average may then be used to determine the object's focus priority.

The weight assigned to each column in determining the focus priority may vary by implementation. For example, some implementations may weigh an object's movement score more highly than an object's position score. Other implementations may use other weights for position and movement. The weights may be determined by the designers of the imaging device based on a target market. For example, some imaging devices may be sold to photographers most interested in prioritizing focus on movement. In these devices, the movement score shown in column (e) may be given the highest weight. In other target markets, large objects may be important. In devices designed for these markets, the object size score shown in column (g) may be given the highest priority.

In some implementations, the weight assigned to each column may be determined by configurable parameters. For example, some implementations may provide for multiple auto focus modes, with the user selecting a particular mode based on their needs. The mode may determine the weights of each column of table 1. For example, an implementation may assign the movement score column a weight of zero unless a “focus on moving objects” auto focus mode has been enabled.

Another autofocus mode, for example “focus on matching color” mode, may assign a higher weight to the color match score of column (c) than to other columns of Table 1. In this mode, the weight of column (d) may be zero. Alternatively, the weight of column (d) may be a weight other than zero, but may have a weight lower than the weight of column (c).

A “focus on objects of a unique color” mode may assign a higher weight to the color uniqueness score, shown in column (d). In this mode, the weight of column (c) may be zero. Alternatively, the weight of column (c) in this mode may be a weight other than zero, but may be lower than the weight of column (d).

In some implementations, the weights assigned to one or more columns may be directly configurable. This capability may be provided for in an “advanced configuration” mode, providing advanced photographers with the ability to customize and tune the autofocus method of the imaging device or camera.

The implementation represented by column (h) provides object 820 with the highest focus priority. Objects 810 and 860 have the second highest focus priority. Objects 830, 840, and 850 each have the lowest focus priority in this implementation. This implementation may have weighted the object movement column higher than some other columns when determining the focus priority. For example, column (h) may represent the focus priority determined when an imaging device is in a “focus on moving objects” mode. In this mode, despite the fact that the object 810's color is somewhat unique, and object 810 is positioned close to the center of the image, the airplane 820's focus priority is higher than the person 810's focus priority.

The implementation represented by column (i) achieves different focus priorities for the same objects. Column (i) may represent an implementation that includes an autofocus mode that focuses on objects of a particular color. The results shown in column (i) may be produced when this mode is active. In this example, the implementation may have been configured to focus on orange objects. In this mode, column (e), which represents the movement score of an object, may receive a lower weight in determining the focus priority than it received in the implementation represented by column (f). For example, column (e) may receive a weight of zero in this autofocus mode. Alternatively, column (e) may receive a non-zero weight in this autofocus mode.

In the image represented by FIG. 8, both objects 810 and 860 have a detected color of orange. With this imaging environment, some implementations may select both orange objects to focus on. In these implementations, a determination may be made as to whether a single focal distance can achieve an adequate focus for both objects. If it can, no further adjustments may be performed and an image may be captured at the appropriate focal distance. If a determination is made that both objects cannot be brought adequately into focus given the current imaging parameters, some adjustments may be made. For example, some implementations may adjust the depth of field of the image so as to provide adequate focus to all the selected objects.

Other implementations may further differentiate between objects of the same color based on the object's relative position within the image. For example, the implementation that generated focus priorities given in column (i) may further prioritize objects of the same color based on each object's position within the image. In the illustrated implementation, object 860 has a lower position score than object 810. This may be caused by object 810 being closer to the center of the image than object 860. In the implementation illustrated by column (i), the position score of each object is determinative in prioritizing object 810 for focus ahead of object 860.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

We claim:

1. A method of focusing a digital imaging device, comprising:
capturing an image with an image sensor, wherein the captured image comprises objects and background;
identifying one or more objects within the image;
selecting at least one of the identified objects to focus on based, at least in part, on the identified object's movement; and
autofocusing the image sensor on the at least one selected object.

2. The method of claim 1, wherein selecting at least one of the identified objects comprises determining motion vectors for at least a portion of the one or more identified objects, wherein the selecting is based, at least in part, on the size of the motion vectors.

3. The method of claim 1, wherein the selecting of at least one of the identified objects is based, at least in part, on the identified objects' movement relative to an image background.

4. The method of claim 1, wherein the selecting of at least one of the identified objects is based, at least in part, on the identified objects' movement being consistent with a pan motion of the device.

5. The method of claim 1, wherein selecting at least one of the identified objects is based, at least in part, on the identified objects' relative position within the image.

6. The method of claim 1, wherein autofocusing the image sensor comprises receiving input indicating the image sensor should be focused, at least in part, on the movement of the at least one selected object.

7. The method of claim 6, further comprising displaying a user interface on an electronic display indicating whether the image sensor should be focused, at least in part, on object movement.

8. The method of claim 1, wherein selecting at least one of the identified objects is further based on one or more colors of the identified objects.

9. The method of claim 1, further comprising:
identifying at least two objects within the image, wherein autofocusing the image sensor on the selected object includes adjusting an aperture of the image sensor to focus the image sensor on the at least two objects.

10. The method of claim 1, further comprising:
predicting a position of one or more objects at a point in time based on each object's motion, wherein the one or more objects includes the at least one object selected for focus, and wherein the autofocusing of the image sensor is based on the selected at least one object's predicted position.

11. An imaging device, comprising:
an image sensor;
a sensor control module configured to capture an image with the image sensor;
an object detection module configured to identify one or more objects within the captured image;
a focus prioritization module configured to select at least one object to focus on based, at least in part, on the at least one object's movement; and
a master control module, configured to autofocus the image sensor on the selected at least one object.

12. The device of claim 11, further comprising an object motion detection module configured to determine motion vectors for at least a portion of the one or more identified objects.

13. The device of claim 11, wherein the focus prioritization module is further configured to select at least one object to focus on based, at least in part, on the at least one object's movement relative to an image background.

14. The device of claim 11, wherein the focus prioritization module is further configured to select at least one of the identified objects based, at least in part, on the at least one object's movement being substantially consistent with a pan of the device.

15. The device of claim 11, wherein the focus prioritization module is further configured to select at least one object based, at least in part, on the at least one object's position within the image.

16. The device of claim 11, further comprising an input processing module, configured to receive input indicating that the image sensor should be focused based, at least in part, on the at least one object that is moving.

17. The device of claim 11, further comprising an electronic display, wherein the master control module is further configured to display a user interface indicating whether the image sensor should be focused, at least in part, on object movement.

18. An imaging device, comprising:
means for capturing an image with an image sensor, wherein the captured image comprises objects and background;
means for identifying one or more objects within the image;
means for selecting at least one of the identified objects to focus on based, at least in part, on the at least one object's movement; and
means for autofocusing the image sensor on the at least one selected object.

19. The imaging device of claim 18, wherein the means for capturing an image comprises an image sensor.

20. The imaging device of claim 18, wherein the means for selecting one of the identified objects selects the object based, at least in part, on the size of the motion vectors.

21. The imaging device of claim 18, wherein the means for selecting an object selects an object also based, at least in part, on the object's relative position within the image.

22. The device of claim 18, wherein the means for selecting selects an object to focus on based, at least in part, on the object's movement relative to an image background.

23. The device of claim 18, wherein the means for selecting selects an object to focus on based, at least in part, the object's movement being substantially consistent with a pan of the device.

24. The imaging device of claim 18, further comprising:
means for predicting a position of one or more objects at a point in time based on each object's motion, wherein the one or more objects includes the object selected for focus, and wherein the autofocusing of the image sensor is based on the selected object's predicted position.

25. A method of focusing a digital imaging device, comprising:
receiving input from a user indicating a selected color;
capturing an image with an image sensor;
identifying one or more objects within the captured image;
selecting a first object to focus on based, at least in part, on the selected color; and
autofocusing the image sensor on the selected object.

26. The method of claim 25, wherein the selecting of the first object to focus on is also based on the first object's relative position within the image.

27. The method of claim 25, further comprising selecting at least a second object to focus on based, at least in part, on the selected color, wherein the autofocusing includes focusing on both the first object to focus on and the second object to focus on.

28. The method of claim 25, wherein selecting a first object to focus on is further based, at least in part, on one or more of the first object's size within the captured image.

29. The method of claim 25, further comprising receiving input indicating a second color not to focus on, wherein the selecting of the first object to focus on is further based on the second color.

30. An imaging device, comprising:
an image sensor;
an input device;
an input processing module, configured to receive input from the input device indicating a selected color;
a sensor control module, configured to capture an image with the image sensor;
an object detection module, configured to identify one or more objects within the captured image;
a focus prioritization module, configured to select at least one object to focus on based, at least in part, on the selected color; and
a master control module, configured to autofocus the image sensor on the at least one selected object.

31. The device of claim 30, further comprising an electronic display configured to display a prompt for input on the color to focus on.

32. The device of claim 30, wherein the focus prioritization module is further configured to select an object based at least in part on the object's position within the image.

33. The device of claim 30, wherein the focus prioritization module is further configured to select an object based at least in part on the object's size within the captured image.

34. The device of claim 30, wherein the focus prioritization module is further configured to select an object based at least in part on the object's movement relative to an image background.
